(19) United States
(12) Patent Application Publication
(10) Pub. No.: US 2020/0290675 A1
(43) Pub. Date: Sep. 17, 2020

(54) CONTROL DEVICE FOR AUTONOMOUS DRIVING SYSTEM AND CONTROL METHOD IMPLEMENTED BY THE CONTROL DEVICE

(71) Applicant: TOYOTA JIDOSHA KABUSHIKI KAISHA, Toyota-shi (JP)

(72) Inventors: Mitsugu MAKITA, Nagoya-shi (JP); Shuichi TAMAGAWA, Kitanagoya-shi (JP); Keigo HIRUMA, Kariya-shi (JP); Shogo NAKATA, Kariya-shi (JP)

(73) Assignee: TOYOTA JIDOSHA KABUSHIKI KAISHA, Toyota-shi (JP)

(21) Appl. No.: 16/790,819

(22) Filed: Feb. 14, 2020

(30) Foreign Application Priority Data
Mar. 14, 2019 (JP) 2019-047636

(51) Int. Cl. B62D 15/02; F02N 11/08

(52) U.S. Cl. CPC B62D 15/024; B60W 2050/0001; F02N 11/0833

(57) ABSTRACT

There is provided a control device for an autonomous driving system for a vehicle in which a steering device configured to be mechanically coupled to a wheel is not provided in a vehicle cabin. The control device includes: a storage unit configured to store a parameter relating to an angle of the wheel calculated from a value of a relative angle sensor configured to detect a relative angle of the wheel; and a controller configured to read the parameter from the storage unit at a time of next power supply restart and control traveling of the vehicle based on a value of the read parameter.

### CROSS-REFERENCE TO RELATED APPLICATION

This application claims priority to Japanese Patent Application No. 2019-047636 filed on Mar. 14, 2019, incorporated herein by reference in its entirety.

### BACKGROUND

### 1. Technical Field

The disclosure relates to a control device for an autonomous driving system, and relates also to a control method implemented by the control device.

### 2. Description of Related Art

As a technique for accurately ascertaining an angle of a steering device at the time of start-up of a system of a vehicle, a technique in which a steering angle at the time of ignition (IG)-off is stored in a memory and a current value of a steering angle sensor is corrected using the stored value is disclosed (for example, see Japanese Unexamined Patent Application Publication No. 2014-015153 (JP 2014-015153 A)). According to this technique, on the precondition that, as in commonly-used vehicles, a steering device and a steering shaft are provided in a vehicle, an absolute steered angle of a wheel is detected based on, for example, an amount of rotation of the steering shaft. The absolute steered angle of the wheel has a one-to-one correspondence relationship with the amount of rotation of the steering shaft.

### SUMMARY

However, in vehicles that mainly perform autonomous driving, a configuration in which a steering device is eliminated from a vehicle cabin (a steering device is not provided in the vehicle cabin) will be actually employed in the near future. Conventional steered angle detection systems cannot be applied to vehicles that are not provided with, for example, a steering device and a steering shaft connected to the steering device. Therefore, there is a possibility that presently-used steered angle detection systems based on the foregoing conventional technique will no longer be used. However, sufficient studies have not been made regarding what kind of technique or method is most suitable for ascertaining an angle of a wheel at the time of start-up of a system of a vehicle, instead of the foregoing technique.

The disclosure provides a control device for an autonomous driving system, configured to accurately ascertain an angle of a wheel at the time of power supply restart in an autonomous driving vehicle in which a steering device is not provided in a vehicle cabin, and also provides a control method implemented by the control device.

An aspect of the disclosure relates to a control device for an autonomous driving system for a vehicle in which a steering device configured to be mechanically coupled to a wheel is not provided in a vehicle cabin. The control device includes: a storage unit configured to store a parameter relating to an angle of the wheel calculated from a value of a relative angle sensor configured to detect a relative angle of the wheel; and a controller configured to read the parameter from the storage unit at a time of next power supply restart and control traveling of the vehicle based on a value of the read parameter.

In the autonomous driving vehicle, the frequency at which the wheel moves at the time of power supply cutoff is extremely low. In view of this, it is considered that, even if a sensor that measures an absolute angle of the wheel is not provided, it is possible to highly accurately predict an angle of the wheel at the time of power supply restart from the value of the relative angle sensor. With the control device of the above aspect based on the foregoing knowledge, it is possible to ascertain an angle of the wheel of the vehicle in which a steering device configured to be mechanically coupled to the wheel is not provided in the vehicle cabin.

In the control device of the above aspect, the parameter relating to the angle of the wheel may be a virtual steering angle.

According to the disclosure, it is possible to highly accurately ascertain an angle of a wheel at the time of power supply restart in an autonomous driving vehicle in which a steering device is not provided in a vehicle cabin.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a block diagram illustrating an example of a configuration of a control device in an autonomous driving system, an example of a configuration of a power steering system, and so forth; and

FIG. 2 is a flowchart illustrating an example of processing relating to a steered angle value from power supply start until power supply cutoff in the autonomous driving system.

### DETAILED DESCRIPTION OF EMBODIMENTS

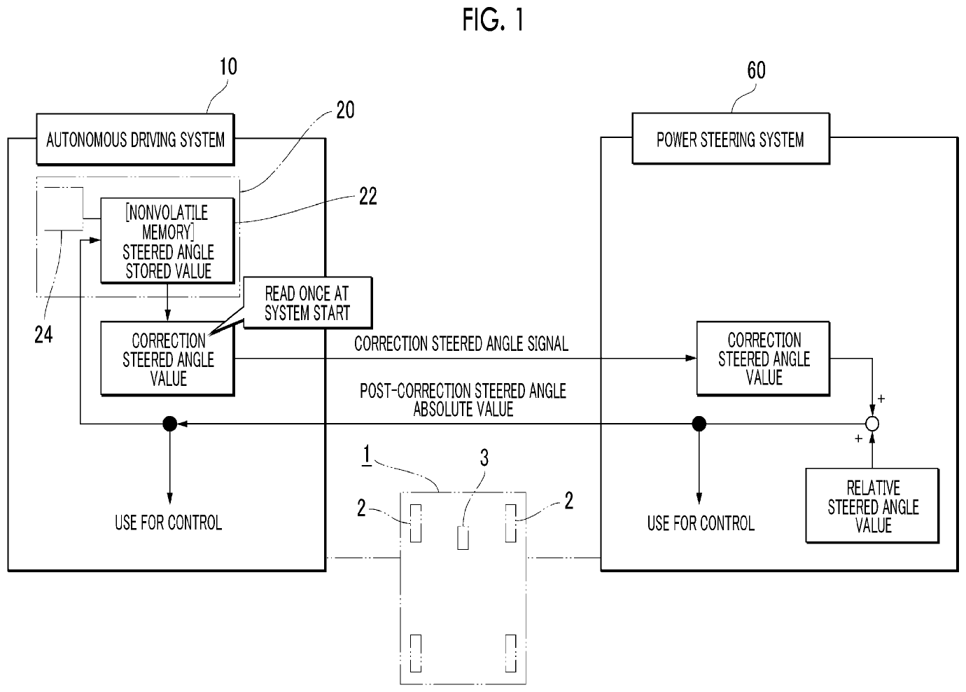

Hereinafter, an autonomous driving system according to an example embodiment will be described with reference to the accompanying drawings (see FIG. 1).

Configuration of System

The outline of the configuration of an autonomous driving system 10 of a vehicle 1 according to the present embodiment will be described (see FIG. 1).

The vehicle 1 is a vehicle that can perform autonomous driving under the control of the autonomous driving system 10. The vehicle 1 of the present embodiment has a configuration in which a steering device configured to be mechanically coupled to wheels 2 is not provided in a vehicle cabin. The wheels 2 of the vehicle 1 are automatically steered through cooperative control of the autonomous driving system 10 and the power steering system 60. A steered angle of the wheels 2 is detected by a relative angle sensor 3.

The autonomous driving system 10 includes a control device 20 configured to control predetermined in-vehicle devices of the vehicle 1. The control device 20 includes a nonvolatile memory 22 and a processor 24. The autonomous driving system 10 of the present embodiment periodically records the steered angle in the nonvolatile memory 22. In this way, the autonomous driving system 10 stores a parameter relating to an angle of the wheels 2 immediately before power supply cutoff. Then, when the system is restarted, the autonomous driving system 10 calls the parameter immediately before power supply cutoff, which is stored in the nonvolatile memory 22, and reflects the parameter in calculation.

The power steering system 60 is a system configured to automatically steer the vehicle 1. The power steering system 60 drives a motor (not illustrated) based on a signal transmitted from the autonomous driving system 10, thereby steering the wheels 2 (see FIG. 1).

Processing Flow

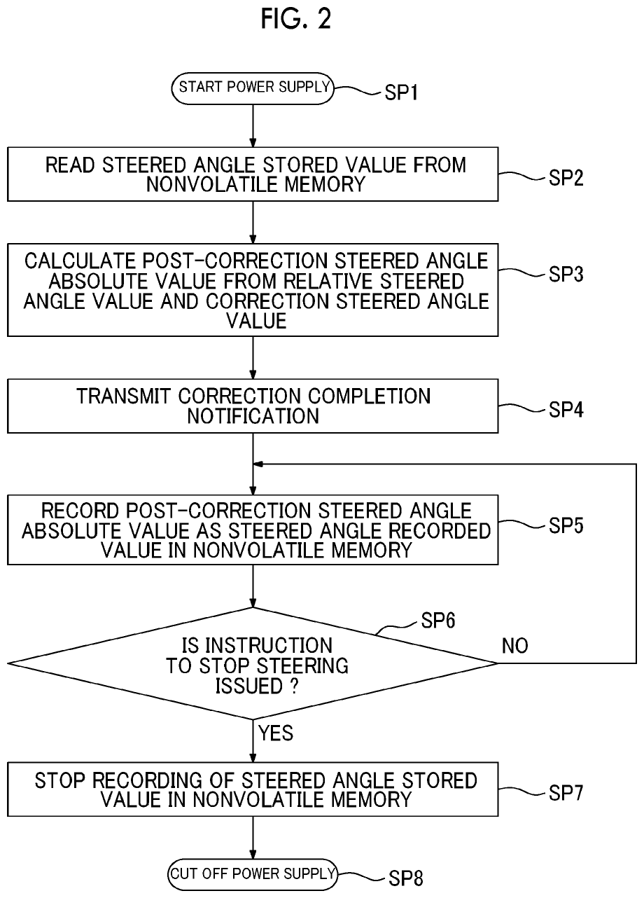

Next, description will be provided on an example of processing relating to a steered angle from power supply start until power supply cutoff, which is executed by the control device 20 of the autonomous driving system 10 (see FIG. 2).

When power supply is started upon restart of the system (Step SP1), the control device 20 reads a parameter (e.g., a steered angle stored value immediately before power supply cutoff) relating to an angle of the wheels 2, which is stored in the nonvolatile memory 22 (Step SP2), and ascertains a steered angle value of the wheels 2 at this time. In the power steering system 60, a post-correction steered angle absolute value” is calculated from the value (“correction steered angle value”) read by the control device 20 and the value (“relative steered angle value”) detected by the relative angle sensor 3 (Step SP3). The “post-correction steered angle absolute value” is used for control (see FIG. 2).

Then, a correction completion notification is transmitted (Step SP4), and the “post-correction steered angle absolute value” is recorded as a steered angle recorded value in the nonvolatile memory 22 (Step SP5). When a signal (steering stop instruction) indicating an instruction to stop steering is not issued (NO in Step SP6), a latest value of the “post-correction steered angle absolute value”, which is updated from moment to moment, is repeatedly recorded in the nonvolatile memory 22 (Steps SP5 and SP6). On the other hand, when a signal (steering stop instruction) indicating an instruction to stop steering is issued (YES in Step SP6), recording of the steered angle stored value in the nonvolatile memory 22 is stopped (Step SP7).

Then, power supply for the autonomous driving system 10 and so forth is cut off in response to an IG-off operation (or a signal indicating an IG-off operation) (Step SP8). At this time, the latest value of the “post-correction steered angle absolute value” recorded as the steered angle recorded value in the nonvolatile memory 22 is stored, as the steered angle stored value immediately before power supply cutoff, in the nonvolatile memory 22.

With the control device 20 for the autonomous driving system 10 described above, it is possible to accurately ascertain an angle of the wheels 2 at the time of power supply restart in the autonomous driving vehicle having a configuration in which a steering device is not provided in the vehicle cabin, as in the present embodiment.

In addition, the autonomous driving system 10 stores a steered angle detection value immediately before power supply cutoff (system OFF), confirms the validity (correctness) of the stored steered angle detection value at the next power supply start (system ON), and then, uses the steered angle detection value for calculation of an absolute steered angle provisional value as a relative steered angle reference value during current system operation. In this way, it is possible to highly accurately predict or ascertain an angle of the wheels 2 at the time of power supply restart based on the detection value of the relative angle sensor 3. Accordingly, since there is no need to provide a sensor that measures an absolute angle of a wheel, it is possible to achieve reduction in the number of parts and simplification of the configuration.

In the autonomous driving system 10 described above, a virtual steering angle is calculated as a parameter relating to an angle of the wheels 2, whereby it is possible to control a vehicle based on a control logic of a control device for a vehicle that is operated by a conventional steering device.

While the foregoing embodiment is an example embodiment, the disclosure is not limited to the foregoing embodiment, and various modifications may be made to the foregoing embodiment within the scope of the disclosure.

The disclosure is suitably applied to an autonomous driving vehicle, and especially suitable for an autonomous driving vehicle in which a steering device is not provided in a vehicle cabin.

What is claimed is:

1. A control device for an autonomous driving system for a vehicle in which a steering device configured to be mechanically coupled to a wheel is not provided in a vehicle cabin, the control device comprising:
a storage unit configured to store a parameter relating to an angle of the wheel calculated from a value of a relative angle sensor configured to detect a relative angle of the wheel; and
a controller configured to read the parameter from the storage unit at a time of next power supply restart and control traveling of the vehicle based on a value of the read parameter.

2. The control device according to claim 1, wherein the parameter relating to the angle of the wheel is a virtual steering angle.

3. A control method for an autonomous driving vehicle, the control method being implemented by the control device according to claim 1.
